(19) United States
(12) Patent Application Publication
(10) Pub. No.: US 2016/0089829 A1
(43) Pub. Date: Mar. 31, 2016

(54) METHOD FOR MANUFACTURING A PACKAGE, A BLANK AND A PACKAGE MANUFACTURED WITH SAID METHOD

(71) Applicant: PAPERFOAM HOLDING B.V., Barneveld (NL)

(72) Inventors: Willem Frederik Derkman, Barneveld (NL); Menno Eduard Groenevelt, Barneveld (NL)

(73) Assignee: PaperFoam Holding B.V., Barnesveld (NL)

(21) Appl. No.: 14/891,711

(22) PCT Filed: May 20, 2014
(86) PCT No.: PCT/NL2014/050317

§ 371 Date: Nov. 17, 2015

(30) Foreign Application Priority Data
May 22, 2013 (NL) 2010835

(51) Int. Cl. B29C 53/04; B65D 25/10; B65D 5/56; B65B 5/02; B65D 5/20

(52) U.S. Cl. CPC B29C 53/04; B65B 5/024; B65D 5/20; B65D 5/563; B65D 25/10; B29K 2003/00; B29L 2031/712

(57) ABSTRACT

Method for manufacturing a package with a blown foam structure and of a material at least comprising natural polymers such as starch, wherein the method comprises providing a mould with a mould cavity and inserting a starch batter in the mould cavity, moulding of a blank in said mould cavity from said starch batter, wherein the blank comprises a bottom panel and first and second side wall panels pivotally connected to the bottom panel along respective folding lines extending between said bottom panel and the respective first and second sidewall panels, removing the blank from the mould cavity, folding of the respective side wall panels along the respective folding lines in a substantially upward position such that adjacent side wall panels abut each other and form a package side wall that extends along a perimeter of said bottom, said side wall and the bottom defining a package inner space.

### FIELD OF THE INVENTION

The present invention relates to a method for manufacturing a package, wherein the package has a blown foam structure and is of a material at least comprising natural polymers such as starch.

### BACKGROUND

It is known to manufacture a package of a material at least comprising natural polymers such as starch and having a blown foam structure. Such a package may have a minimum weight and may be used to receive and hold fragile and/or breakable products. Such packages may be manufactured by moulding such packages from a bio-polymer material from renewable resources, such as a starch based material. A method for manufacturing such a package is known from practice. Such method may for instance comprise supplying a starch based starting material comprising water as blowing agent under pressure into a mould. The mass in the mould is heated such as to give rise to gelatinization and cross-linking of the natural polymers such that the product is formed. When manufacturing the package by means of such method, the package needs to have a withdrawable shape and suitable clearance angles have to be chosen to enable removal of the package from the mould cavity without damaging the package.

Alternative packages are also known from practice such as packages made from cardboard, plastics and wood. Such packages may for instance be used to package electronics and/or luxury goods and therefore need to have an appealing character. Said packages may be manufactured by different manufacturing methods resulting in a package of which the outer corners may have substantially sharp angles. Such packages can be stacked on top of each other easily, which is advantageous with respect to transporting costs of products provided in such packages. However, the manufacturing costs for manufacturing such packages may be relatively high. Besides, manufacturing of a package from a bio-polymer material from renewable resources provides a more environmental friendly alternative.

In view of the above, it is an object of the invention to provide an improved method for manufacturing a package from a material at least comprising natural polymers such as starch. More in particular, it is an object of the invention to provide a method for manufacturing a package from a material at least comprising natural polymers such as starch, wherein the package characteristics, such as shape and appearance, are comparable with packages manufactured from cardboard, plastics and/or wood.

### SUMMARY OF THE INVENTION

Therefore, in a first aspect, a method according to the invention for manufacturing a package having a blown foam structure and said package being of a material at least comprising natural polymers such as starch, is provided. The method may comprise providing a mould with a mould cavity and inserting a starch batter in said mould cavity, moulding of a blank in said mould cavity from said starch batter. The blank may comprise a bottom panel and first and second side wall panels pivotally connected to the bottom panel along respective folding lines extending between said bottom panel and the respective first and second sidewall panels. The method can further comprise removing of the blank from the mould cavity and folding of the respective side wall panels along the respective folding lines in a substantially upward position such that adjacent side wall panels abut each other and form a package sidewall extending along a perimeter of said bottom, said sidewall and the bottom enclosing a package inner space.

By manufacturing a package from a bio-polymer material by first moulding a blank and subsequently folding said blank to obtain a package, the package may be provided with sharp outer corners and may have substantially flat outer surfaces. Consequently, such package may be an alternative to packages of cardboard, plastics, wood and the like material. Due to the shape of said package, the package has taut lines and may be stacked easily. Due to said manufacturing method, the side wall panels may be positioned substantially perpendicular to the bottom panel or to the other side wall panels, thus forming an angle of approximately 90 degrees. However, the panels may include any other angle, dependent on the design of the blank and the package. Besides, the package manufactured with the method according to the invention has the advantage that it is made from a biodegradable material and thus is a sustainable alternative to the packages manufactured from the above mentioned materials. Furthermore, the package manufactured by the method according to the invention has a minimum weight which is advantageous with respect to transportation costs of packaged products.

To be able to fold the side wall panels in the upright position, thus in a position in which the side wall panels extend from the bottom panel in a direction facing away from said bottom panel, the respective folding lines may be formed by providing recessed areas in the blank during moulding of the blank. The recessed areas may be formed in the blank by providing little space between the respective mould parts of the mould such that the skins that are formed on both opposing outer surfaces of the blank are provided close to each other. Consequently, little material is provided in between said skins, enabling folding of the side wall panels and at the same time thereby minimizing the risk of cracking of the skin during the folding operation.

The recessed area may be also be formed by compressing the area of the folding lines to decrease the thickness of the blank at that specific location. Compression of the area may also be applied after providing the recessed area in the blank due to the shape of the mould.

Preferably, the density of the material at a location of the folding lines, i.e. in between the skins, is higher than the density of the material in the blank at locations other than at the folding line locations. Preferably, the thickness of the blank at a location of the folding lines is smaller than the thickness of the blank at locations other than at the folding lines locations.

The side wall panels may be interconnected, at least opposing edges of adjacent side wall panels may be interconnected. By interconnecting the respective side wall panels, the package will be provided with the desired strength, such as the strength in a direction extending substantially parallel to the corners of the side wall panels.

In a further aspect, the method according to the invention can be characterized in that the blank may be provided with a laminate layer on at least one of the blank surfaces. By providing the blank with a laminate layer such that an outer surface of the package is laminated, for instance with a paper or a plastic layer, the package may be provided with a print, for instance a full color print. Such print may be provided on the laminate layer before connection of said layer to the blank surface.

Additionally or alternatively, at least one of the outer surfaces of the blank may be provided with a text and/or image, for instance by means of printing. Due to the material of the blank, the outer surface may be substantially smooth which enables direct printing thereon.

The blank may, alternatively or additionally, comprise a laminate layer on the other one of the blank surfaces, for instance on the inner surface of the package. The side wall panels may be interconnected by means of the at least one laminate layer, for instance by means of adhering part of the laminate layer to another, opposing part of said laminate layer.

In another aspect of the method according to the invention, at least one of the bottom panel and/or the first side wall panels may be provided with a protrusion in the same method step in which the blank is moulded. The at least one protrusion is integrally formed with the blank. In this description, integrally formed is understood to mean formed with material common to the rest of the blank and the connection of respective parts having no mechanical joints. Thus, the blank is a single integrally formed piece. In this description, single integrally formed piece is understood to mean having no parts that separate from the blank during normal operation and containing no parts that are not integrally formed.

The method according to the invention thus enables providing the package with one or more corner reinforcements, product retainers, package inner space dividers and the like, formed by the protrusions, in the moulding step of the manufacturing method. Consequently, the amount of method steps used for manufacturing said package is minimized, which is advantageous in view of the manufacturing costs.

A further advantage of the fact that the protrusions are provided on the blank is that the product to be packaged can be positioned with respect to the bottom panel, or if applicable with respect to any other panel of the blank, before folding of the side panels in the upright position. After positioning of the product, the package may be formed by folding of the blank and fixating of the respective panels to each other, thereby enclosing and/or fixating the product in the package. Such a package may thus have a tamper evident construction.

The invention also relates to a blank for forming a package and to a package set up from a blank, wherein the package is manufactured by means of the above described manufacturing method.

The aforementioned and other features and advantages of the invention will be more fully understood from the following detailed description of certain embodiments of the invention, taken together with the accompanying drawings, which are meant to illustrate and not to limit the invention.

### BRIEF DESCRIPTION OF THE DRAWINGS

FIG. 1 shows a schematic perspective view of a blank according to an embodiment of the invention;

FIG. 2 shows a cross sectional view of the blank according to FIG. 1;

FIG. 3 shows a schematic perspective view of a package according to an embodiment of the invention set up from the blank according to FIG. 1;

FIG. 4 shows a schematic perspective view of a blank according to a further embodiment of the invention;

FIG. 5 shows a cross sectional view of the blank according to FIG. 4;

FIG. 6 shows a schematic perspective view of a package according to a second embodiment of the invention set up from the blank according to FIG. 4;

FIG. 7 shows a schematic perspective view of a blank according to a third embodiment of the invention;

FIG. 8 shows a schematic perspective view of a package according to a third embodiment of the invention set up from the blank according to FIG. 7;

FIG. 9 shows a schematic perspective view of a blank according to a fourth embodiment of the invention; and

FIG. 10 shows a schematic perspective view of a package according to a fourth embodiment of the invention set up from the blank according to FIG. 9.

In this specification, identical or corresponding parts may have identical or corresponding reference numerals. Where required, for a better understanding of a Figure, reference is made to the description of other Figures. Combinations of (parts of) the embodiments shown are expressly understood to also be incorporated and described herein.

### DETAILED DESCRIPTION

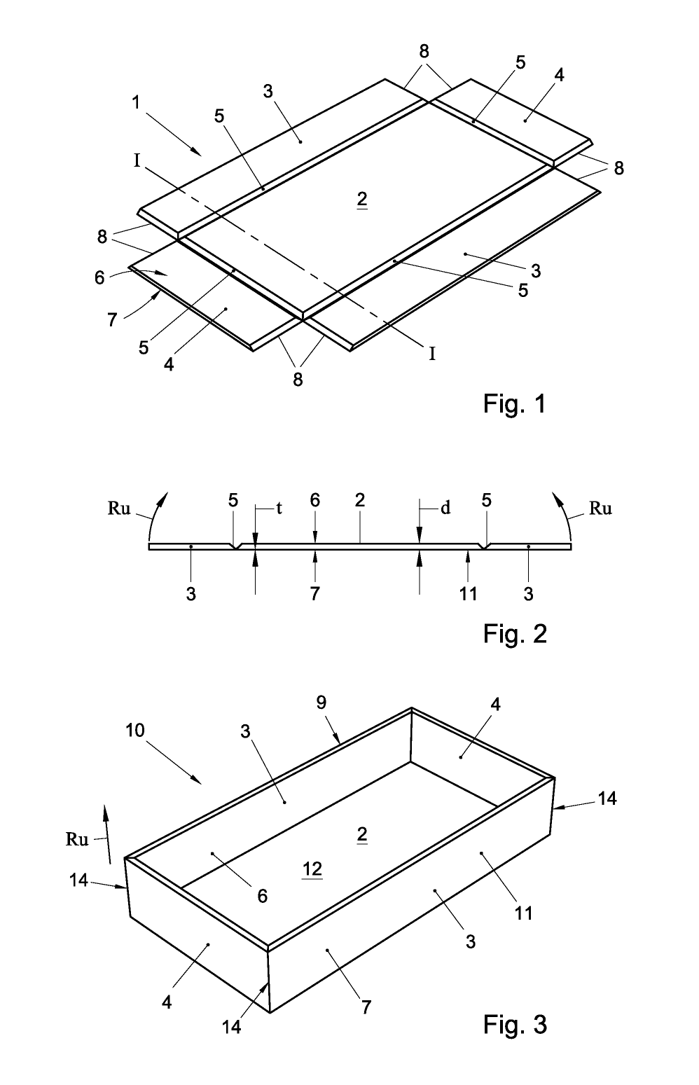

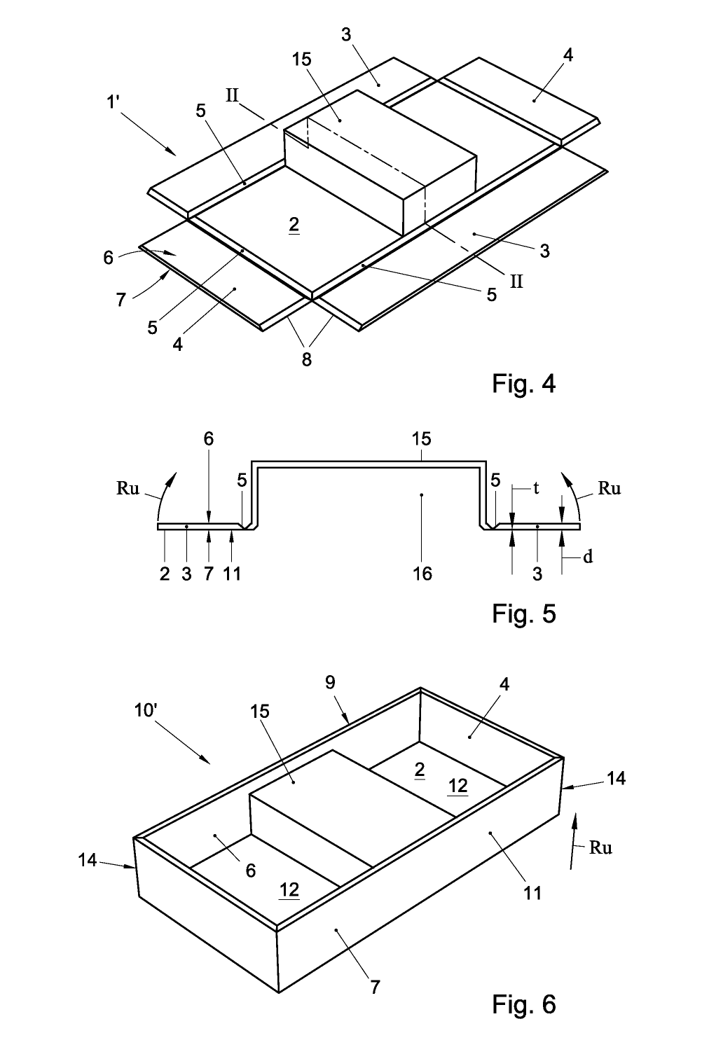

FIG. 1 shows in a schematic perspective view a blank 1 according to a first embodiment of the invention. The blank 1 comprises a quadrangular bottom panel 2 and first and second side wall panels 3, 4 mutually opposed, in pairs. The first and second side wall panels 3, 4 are connected to the bottom panel 2 via folding lines 5 and are configured to be pivoted along said folding lines 5 to be brought in an upright position. The blank 1 has a blown foam structure and is of a material at least comprising natural polymers such as starch. The folding lines 5 are formed by a longitudinally extending recessed area in the blank 1 in which area the thickness t of the blank 1 is smaller than the thickness d outside said area (see FIG. 2 in which a cross section is shown of the blank 1 according to FIG. 1, according to line I-I in FIG. 1). The thickness t may be between 0.1-0.5 mm, preferably between 0.2 and 0.4 mm. The blank 1 is manufactured by means of an injection moulding process. A starch batter is introduced into a mould cavity. Preferably, the starch batter is heated in the mould to dry the mass to form the blank 1. At the contact surface of the starch batter and the mould cavity, a skin is formed, thus on all outer surfaces of the blank 1. In the mould cavity, the distance between the mould parts is smaller at the location of the folding lines than at any other location on the blank. Due to said smaller opening between the mould parts, recessed lines are formed in the blank, at least in one of the blank outer surfaces 6, 7. These recessed lines 5 enable the first and second side wall 3, 4 panels to be pivotally connected to the bottom panel 2. After removal of the blank 1 from the mould cavity, the first and second side wall panels 3, 4 are pivoted in a substantially upward direction Ru (see FIG. 2), i.e. a direction facing away from the bottom panel 2. The respective side wall panels 3, 4 are interconnected, at least at opposing edges 8 of the respective side wall panels 3, 4. In the upright position, see FIG. 3, the first and second side wall panels 3, 4 together form a side wall 9 of a package 10 according to an embodiment of the invention. The side wall panels 3, 4 are connected to the bottom via connections that are formed by the folding lines 5. The side wall 9 and the bottom panel 2 define a package inner space 12. The package 10 as shown in FIG. 3 is of a material having a foam blown structure and thus is a relatively light weight package 10. The package 10 may be provided with a laminate layer 11 that is provided on one of the outer surfaces 7 of the blank, and thus on the outer surface 7 of the package 10. Such a laminate layer 11 may for instance be a paper layer or a plastic layer and may provide a suitable basis for applying a print onto said package 10. Additionally or alternatively, a print may be provided directly onto the outer surfaces of the package, thus on surface of the package formed out of the starch based material. Additionally or alternatively, a laminate layer (not shown) may be provided on an inner surface 6 of the package 10. Furthermore, such a laminate layer 11 may enable easy connection of the respective opposing edges 8 of the side wall panels 3, 4, for instance by means of an adhesive.

Due to the construction of the package 10 according to the invention, it is possible to set up a package 10 from the blank 1 which package has substantially sharp outer corners 14. Said outer corners 14 extend between the side wall panels 3, 4 and/or between the side wall panels 3, 4 and the bottom panel 2. Since the outer corners 14 are sharp and thus have a very small radius, the package 10 has an appearance that matches packages of other material, such as plastic packages or wooden packages. Therefore, the package 10 according to the invention provides a suitable alternative for the above mentioned packages. The package 10 may for instance be used to package electronic devices, such as telephones, or other fragile and/or breakable products. Due to the laminate layer 11 that is provided on an outer surface 8 of the package 10, the starch batter to be used to mould the blank 1 may comprise fewer fibres than without using said laminate layer. Besides, the starch batter may be a relatively thin batter. This is advantageous in view of the costs of the starting material.

In FIGS. 4-10, further embodiments of blanks 1′, 1″, 1′″ and packages 10′, 10″, 10″ according to the invention have been shown. In FIGS. 4-6 a second embodiment of a blank 1′ according to the invention and a package 10′ according to the invention have been shown. Since the blank 1′ and the package 10′ resemble the blank 1 and the package 10 as described with FIGS. 1-3, a detailed description of the said blank 1′ and package 10′ is omitted. Only the differences with respect to the first embodiment of the blank 1 and package 10 will be described. The blank 1′ as shown in FIG. 4 is provided with a protrusion 15 that extends from the upper surface of the bottom panel 2 in a direction away from the bottom panel 2. The protrusion 15 has a substantially rectangular shape and extends along the entire width W of the bottom panel 2 and along part of the length L of the bottom panel 2. The protrusion 15 is integrally formed with the blank 1′ during moulding of the blank 1′. Thus in fact, the bottom panel 2, the side wall panels 3, 4 and the protrusion 15 together form a single piece product. As is visible in FIG. 5 (in which a cross section is shown of the blank 1 according to FIG. 4, according to line II-II in FIG. 4), the protrusion 15 is substantially hollow and the wall thickness D of the protrusion 15 is similar to the wall thickness d of the remainder of the blank 1′. After folding the respective side wall panels 3, 4 in the upward direction Ru, the protrusion 15 forms a product retainer that is configured for receiving and/or holding a product in the inner space 12 of the package 10′. Since the protrusion 15 is formed during moulding of the blank 1′, no additional manufacturing steps are necessary to obtain the package 10′ having a product retainer. Furthermore, since the material of the protrusion 15 is the same as the material of the remainder of the blank 1′ the package 10′ is a light weight package. The outer surface 7 and/or the inner surface 6 of the package 10′ may be provided with a laminate layer 11 that preferably is connected to the blank 1′ before folding of the side wall panels 3, 4. The side wall panels 3, 4 may be interconnected at the respective side edges 8 (see FIG. 4) thereof by means of an adhesive. In another embodiment (not) shown, the laminate layer 11 may be provided on the outer surface 7 and/or inner surface 6 of the package 10′ after setting up the package 10′ from the blank 1′. It is noted that the laminate layer may cover the entire outer surface of the blank 1 or part of the outer surface of the blank 1. For instance, a laminate layer can be provided on the outer surface of the blank and at the same time does not cover the protrusions.

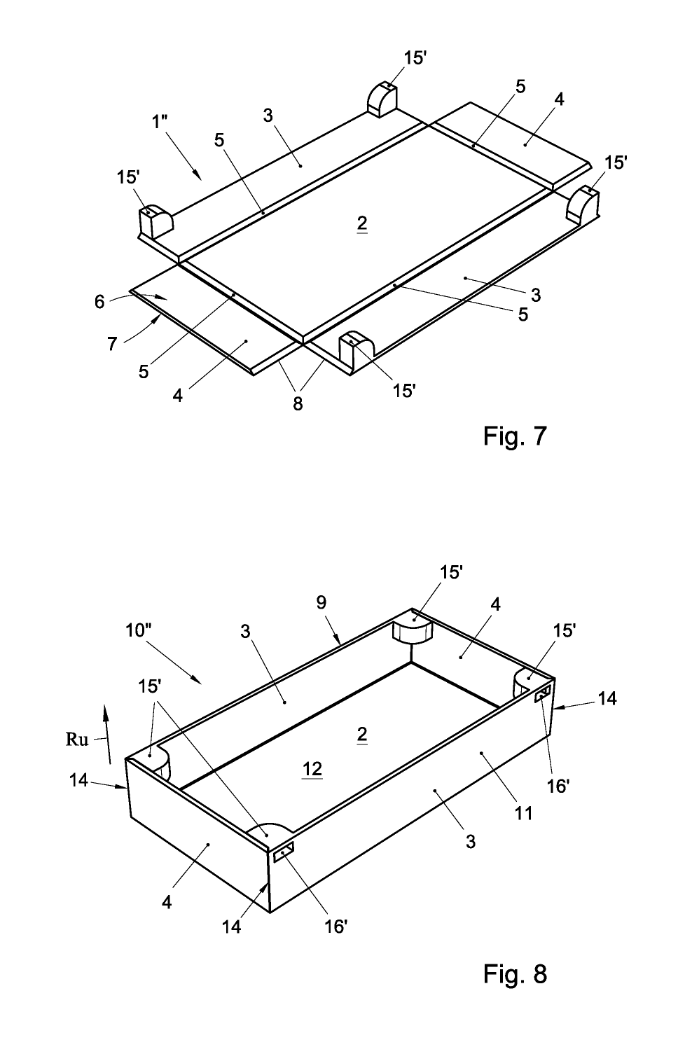

FIGS. 7 and 8 show a third embodiment of the blank 1″ and the package 10″ according to the invention. In this embodiment, the blank 1″ is provided with multiple protrusions 15′ that extend from two opposing first side wall panels 3 substantially upward, i.e. a direction substantially perpendicular to the upper surface 6 of the blank 1″. The protrusions 15′ are provided in the respective corners of the side wall panels 3 such that after setting up the package 10″ from the blank 1″, the protrusions 15′ form corner reinforcements. In the package 10″ shown in FIG. 8, the corner reinforcements 15′ are provided in the inner corners of the side wall 9 of the package remote from the bottom panel 2. In different words, the corner reinforcements extend from an open end of the package 10″ towards the bottom panel 2 along part of the inner corner of the side wall 9. In a different embodiment of the package according to the invention, the corner reinforcements may extend along the entire inner corner of the side wall 9 or may extend from the bottom panel 2 towards the open end of the package 10″ along part of the inner corner. The latter configuration of the corner reinforcements may be configured to hold a further bottom panel at a short distance of the bottom panel 2 of the package 10″.

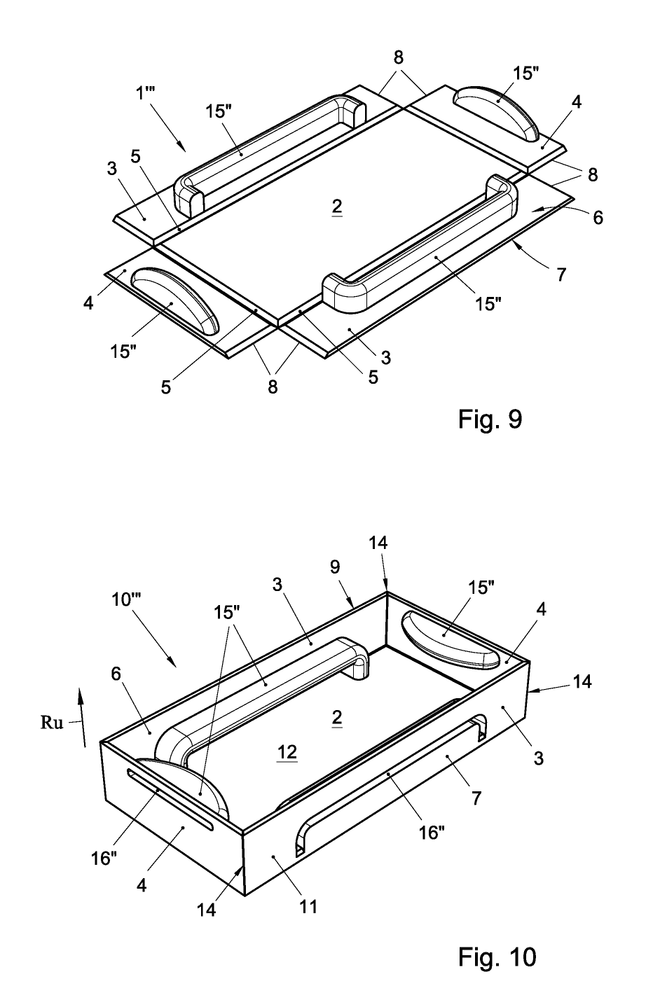

In FIGS. 9 and 10 a fourth embodiment of the blank 1′″ and the package 10′″ is shown. The blank 1′″ as shown in FIG. 9 comprises multiple protrusions 15″ that extend from the first and second side wall panels 3, 4 in a direction away from said respective panel 3, 4. As mentioned before, the protrusions 15″ are substantially hollow and are formed during the moulding step of the blank. Since the protrusions 15″ can be formed during moulding, the protrusions may have different shapes, sizes and be located on different positions on the blank 1′″. In the shown embodiment, the protrusions 15″ are configured for retaining a product in the package inner space 12. After moulding the blank 1′″, the product is placed on top of the bottom panel 2 (not shown). Subsequently, the side wall panels 3, 4 are pivoted along the folding lines 5 and brought in an upright position such that the opposing side edges 8 of the respective side wall panels 3, 4 are in abutment. As the side wall panels 3, 4 are pivoted, the protrusions 15″ are displaced to a position in which said protrusions 15″ partly enclose the product inside the package inner space 12. After interconnecting the respective side edges 8, the product can not be removed from the package without breaking the package 10′″. Thus, the package 10′″ is tamper evident.

Although illustrative embodiments of the present invention have been described above, in part with reference to the accompanying drawings, it is to be understood that the invention is not limited to these embodiments. Variations to the disclosed embodiments can be understood and effected by those skilled in the art in practicing the claimed invention, from a study of the drawings, the disclosure, and the appended claims. It will be clear, for example, that the products that are manufactured by means of the method according to the invention can be of different shapes and dimensions. The blanks can be provided with different protrusions, i.e. protrusions placed on different locations on the respective panels and/or protrusions having different shapes dependent on the function of such protrusions. For instance packages intended for receiving electronic products may have a different kind of protrusions than packages intended for receiving food products or other kinds of products. Furthermore, the starch batter used for moulding of the blank may comprise different ingredients. The laminate layer may be of different materials and may be, for instance in dependence of the product to be packaged, provided on a desired location on the blank and thus on the package.

Reference throughout this specification to “one embodiment” or “an embodiment” means that a particular feature, structure or characteristic described in connection with the embodiment is included in at least one embodiment in the present invention. Thus, the appearances of the phrases “in one embodiment” or “in an embodiment” in various places throughout this specification are not necessarily all referring to the same embodiment. Furthermore, it is noted that particular features, structures or characteristics of one or more embodiments may be combines in any suitable manner to form new, not explicitly described embodiments

1. Method for manufacturing a package, which package has a blown foam structure and is of a material at least comprising natural polymers such as starch, wherein the method comprises:
providing a mould with a mould cavity and inserting a starch batter in the mould cavity;
moulding of a blank in said mould cavity from said starch batter, wherein the blank comprises a bottom panel and first and second side wall panels pivotally connected to the bottom panel along respective folding lines extending between said bottom panel and the respective first and second sidewall panels;
removing the blank from the mould cavity;
folding of the respective side wall panels along the respective folding lines in a substantially upward position such that adjacent side wall panels abut each other and form a package side wall that extends along a perimeter of said bottom, said side wall and the bottom defining a package inner space.

2. Method according to claim 1, wherein the respective folding lines are formed by providing recessed areas in the blank during moulding of the blank.

3. Method according to claim 1, wherein the blank, at least the area of the folding lines, is compressed to locally decrease a thickness of the blank.

4. Method according to claim 1, wherein a shape of the mould cavity is such that a thickness of the blank at a location of a respective folding line is smaller than the thickness of the bottom panel and/or the side wall panels of the blank.

5. Method according to claim 1, wherein a density of the material at a location of a respective folding line is higher than the density of the material in the bottom panel and/or the side wall panels of the blank.

6. Method according to claim 1, wherein the method further comprises interconnecting adjacent side wall panels, at least opposing side edges of adjacent side wall panels.

7. Method according to claim 1, wherein the blank is provided with a laminate layer, for instance a paper or plastic layer, on at least one of the blank surfaces.

8. Method according to claim 7, wherein the adjacent side wall panels are interconnected by means of the laminate layer.

9. Method according to claim 1, wherein on at least one of the blank surfaces or on a laminate layer provided on at least one of the blank surface a text and/or image is provided, for instance by means of printing.

10. Method according to claim 1, wherein during moulding of the blank on at least one of the bottom panel and/or the first and second side wall panels at least one protrusion is provided.

11. Method according to claim 10, wherein the at least one protrusion forms one of a corner reinforcement, a product retainer and a package inner space divider.

12. Method according to claim 1, wherein the first and second side wall panels are folded and/or interconnected after inserting a product in the package inner space.

13. A blank for forming a package, wherein the blank comprises a substantially quadrangular bottom panel, first and second sidewall panels lying mutually opposed, in pairs, which are connected to the bottom panel so as to be pivotable along folding lines, wherein the blank has a blown foam structure and is of a material at least comprising natural polymers such as starch.

14. A blank according to claim 13, wherein a thickness of the blank at a location of the folding lines is smaller than a thickness of the bottom panel and/or the side wall panels.

15. A blank according to claim 13, wherein the blank is provided with at least one protrusion extending from a first blank surface in a direction away from said blank surface, wherein the protrusion is an integrally formed part of the blank.

16. A blank according to claim 13, wherein the blank comprises, at least on one of the blank surfaces, a laminate layer, for instance a paper layer or plastic layer.

17. A blank according to claim 13, wherein the blank is a single integrally formed piece.

18. A package having a blown foam structure and said package being of a material at least comprising natural polymers such as starch, wherein the package comprises a bottom formed by a bottom panel and a side wall surrounding a perimeter of the bottom, said bottom and side wall defining a package inner space, wherein the side wall comprises first and second upstanding side wall panels connected to the bottom, wherein respective connections between said respective side wall panels and the bottom define first package outer corners, wherein adjacent sidewall panels are mutually connected at opposing edges thereof, thereby defining second package outer corners.

19. The package according to claim 18, wherein the package is manufactured according to a method comprising:
providing a mould with a mould cavity and inserting a starch batter in the mould cavity;
moulding of a blank in said mould cavity from said starch batter, wherein the blank comprises a bottom panel and first and second side wall panels pivotally connected to the bottom panel along respective folding lines extending between said bottom panel and the respective first and second sidewall panels;
removing the blank from the mould cavity;
folding of the respective side wall panels along the respective folding lines in a substantially upward position such that adjacent side wall panels abut each other and form a package side wall that extends along a perimeter of said bottom, said side wall and the bottom defining a package inner space,
wherein the package is set up from a blank comprising: a substantially quadrangular bottom panel, first and second sidewall panels lying mutually opposed, in pairs, which are connected to the bottom panel so as to be pivotable along folding lines, wherein the blank has a blown foam structure and is of a material at least comprising natural polymers such as starch, wherein the upstanding side wall panels are connected to the bottom via first and second folding lines, said folding lines defining the respective first package outer corners.

20. The package according to claim 17, wherein the first and second package outer corners are substantially sharp corners.

21. The package according claim 17, wherein on at least one of an inner surface and an outer surface of the package a laminate layer is provided.

22. The package according claim 18, wherein the package comprises at least one protrusion extending from an inner surface of at least one of the bottom panel and the first and second side wall panels.

23. The package according to claim 22, wherein the at least one protrusion forms at least one of a corner reinforcement, a package inner space divider and a product retainer.

24. The package according to claim 23, wherein in the inner space of the package a product is provided, which product is at least partly enclosed and retained by the at least one product retainer, such that the product can only be removed from the package by tearing of the package.

25. The package according to claim 17, wherein the package is a single integrally formed piece.
